(19) United States
(12) Patent Application Publication
(10) Pub. No.: US 2013/0117274 A1
(43) Pub. Date: May 9, 2013

(54) ELECTRONIC DEVICE WITH ADDRESS BOOK AND ADDRESS BOOK MANAGEMENT METHOD

(71) Applicant: JIAN-HUI LI, Shenzhen City (CN)

(72) Inventor: JIAN-HUI LI, Shenzhen City (CN)

(73) Assignees: FIH (HONG KONG) LIMITED, Kowloon (HK); SHENZHEN FUTAIHONG PRECISION INDUSTRY CO., LTD., ShenZhen City (CN)

(21) Appl. No.: 13/626,897

(22) Filed: Sep. 26, 2012

(30) Foreign Application Priority Data
Nov. 4, 2011 (CN) 201110344698.5

(51) Int. Cl. G06F 17/30

(52) U.S. Cl. 707/741; 707/E17.002

(57) ABSTRACT

In an address book management method of an electronic device, a directory of members of an address book is created. A communication bulk and a communication count of each of the members listed in the address book are obtained. The communication bulk for each member is a total quantity of electronic communication in a predetermined time period between a predetermined user of the electronic device and the member, the total quantity measured according to a predetermined criterion, and the communication count for each member is a total number of occasions of electronic communication between the user and the member in the predetermined time period. An accumulative contact quantity index of each member is calculated according to the calculated communication bulk and communication count of the member. Thus, the members in the directory of the address book are ordered according to the accumulative contact quantity indexes.

### BACKGROUND

1. Technical Field

The disclosure generally relates to electronic information management; and particularly to an electronic device with an address book, and an address book management method of the electronic device.

2. Description of the Related Art

Many electronic devices, such as mobile phones and personal computers, provide address book functions for users to establish and maintain an address book. The address book can be a telephone directory, for example. Members listed in the address book are typically shown in alphabetical order. This ordering is simple, but it may be ineffective. In particular, it may be inconvenient for a user to have to search for a person in the address book by means of the first letter of the person's name.

Therefore, there is room for improvement within the art.

### BRIEF DESCRIPTION OF THE DRAWINGS

Many aspects of an exemplary electronic device and address book management method can be better understood with reference to the following drawings. The components in the drawings are not necessarily drawn to scale, the emphasis instead being placed upon clearly illustrating the principles of the present embodiments.

FIG. 1 is a block diagram illustrating one embodiment of an electronic device comprising an address book management system.

FIG. 2 is a schematic diagram illustrating an example of an address book of the address book management system of FIG. 1.

FIG. 3 is a flowchart of one embodiment of an address book management method of the electronic device of FIG. 1.

### DETAILED DESCRIPTION

The disclosure, including the accompanying drawings, is illustrated by way of example and not by way of limitation. It should be noted that references to “an” or “one” embodiment in this disclosure are not necessarily to the same embodiment, and such references can mean “at least one.”

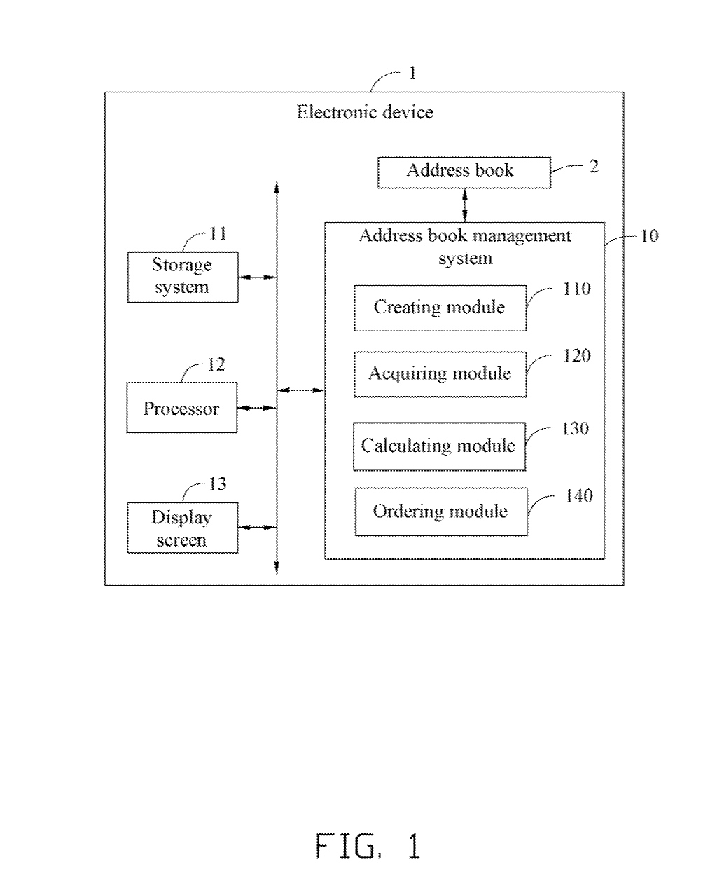

FIG. 1 is a schematic diagram illustrating one embodiment of an electronic device 1 comprising an address book management system 10. In one embodiment, the electronic device 1 may be a mobile phone or a personal computer, for example. In the embodiment, the electronic device 1 further includes a storage system 11, at least one processor 12, and a display screen 13. In the illustrated embodiment, there is only a single processor 12. It is understood that FIG. 1 is only one example of the electronic device 1, and the electronic device 1 can include more or fewer components than those shown in the embodiment, or have a different configuration of the various components.

The address book management system 10 may include a plurality of programs in the form of one or more computerized instructions, which are stored in the storage system 11 and executed by the processor 12 to perform operations of the electronic device 1. In the embodiment, the address book management system 10 includes a creating module 110, an acquiring module 120, a calculating module 130, and an ordering module 140. In general, the word “module,” as used herein, refers to logic embodied in hardware or firmware, or to a collection of software instructions, written in a programming language such as Java, C, or assembly. One or more software instructions in the modules may be embedded in firmware, such as in an erasable-programmable read-only memory (EPROM). The modules described herein may be implemented as either software and/or hardware modules, and may be stored in any type of non-transitory computer-readable medium or other storage device. Some non-limiting examples of non-transitory computer-readable mediums include compact discs (CDs), digital versatile discs (DVDs), Flash memory, and hard disk drives.

In one embodiment, the storage system 11 may be an internal storage system, such as a random access memory (RAM) for temporary storage of information, and/or a read only memory (ROM) for permanent storage of information. In some embodiments, the storage system 11 may also be an external storage system, such as an external hard disk, a storage card, or a data storage medium.

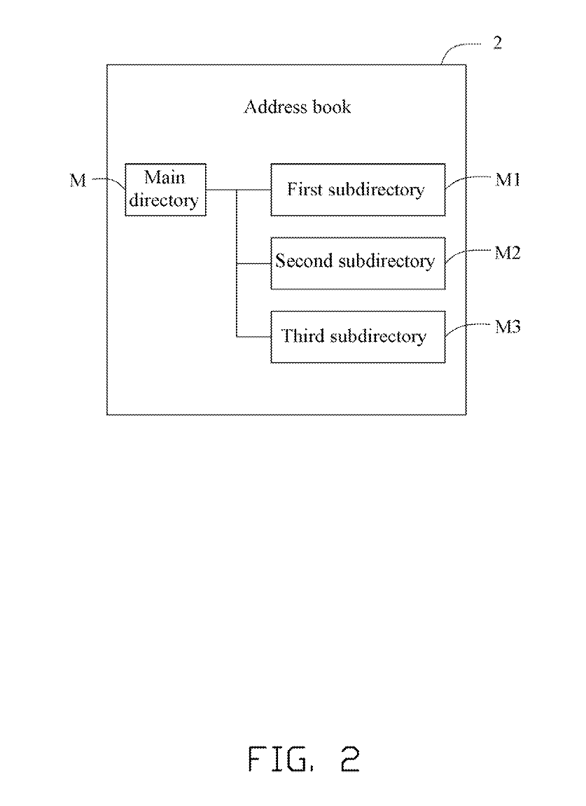

Referring also to FIG. 2, the address book management system 10 is used for ordering members of an address book 2 of the electronic device 1. The address book 2 can be (or comprise) a telephone directory, a mailbox directory (of email addresses), or an instant chat directory (of electronic chat IDs), for example. Communication records between a user of the electronic device 1 and the members of the address book 2 are stored in the storage system 11. Depending on what type of directory the address book 2 is, the communication records can be derived from telephone communications, email communications, or instant chat communications between the user and each member. The communication records at least include a communication bulk and a communication count of each member. The communication bulk is information on the amount of contents of any communications between the user and each member. For example, the communication bulk of any one communication between the user and a member can be a time period of a telephone communication, such as 5 minutes; or the electronic storage size of all the data of the text of an email communication, such as 512 bytes; or the electronic storage size of all the data of the text of an instant chat communication, such as 256 bytes. The communication count can be the total number of telephone communications between the user and the member, such as three times (i.e., occasions), or the total number of email communications between the user and the member, such as five times.

The creating module 110 creates a main directory M for the address book 2, and the main directory M is shown on the display screen 13. In one exemplary embodiment, the main directory M is named as “main contact quantity index,” for indicating an accumulative contact quantity index between the user and each member in a default time period, such as all time up to the present time, for example. The main directory M may further include a first subdirectory M1 named as “a first subsidiary contact quantity index” for indicating an accumulative contact quantity index in the most recent week, a second subdirectory M2 named as “a second subsidiary contact quantity index” for indicating an accumulative contact quantity index in the most recent month, and a third subdirectory M3 named as “a third subsidiary contact quantity index” for indicating an accumulative contact quantity index in the most recent year.

The acquiring module 120 reads the communication records from the storage system 11 according to the main directory M, the first subdirectory M1, the second subdirectory M2, or the third directory M3, as selected by the user. For example, when the user selects the main directory M, the acquiring module 120 reads the communication records in the period of all time up to the present time. When the user selects the second subdirectory M2, the acquiring module 120 reads the communication records in the most recent month.

The calculating module 130 calculates the accumulative contact quantity index according to the communication records read by the acquiring module 120. Specifically, in a typical embodiment, the user instructs the calculating module 130 to predetermine a first weighting coefficient N for the communication count, and a second weighting coefficient P for the communication bulk. Thus, the accumulative contact quantity index can be calculated according to the formula:

accumulative contact quantity index=communication count*N+communication bulk*P

The ordering module 140 arranges the members of the selected main directory M or subdirectory M1, M2 or M3 of the address book 2 according to the calculated accumulative contact quantity indexes. In one exemplary embodiment, the ordering module 140 arranges the member with a highest accumulative contact quantity index in a frontmost position of the selected main directory M or subdirectory M1, M2 or M3 of the address book 2.

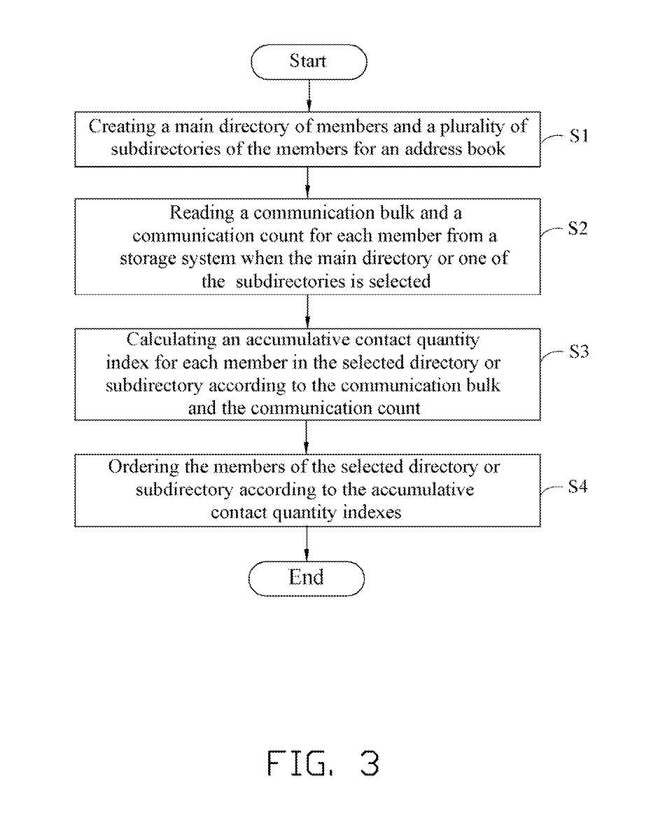

FIG. 3 is a flowchart of one embodiment of an address book management method of the electronic device 1. Depending on the embodiment, additional blocks may be added to the flowchart, others removed, and the ordering of the blocks may be changed. In the following description, the address book 2 is taken to be a telephone directory, by way of example.

In block S1, the creating module 110 creates the main directory M of members and the subdirectories M1-M3 of the members for the address book 2. In the embodiment, the main directory M and the subdirectories M1-M3 are then, when required to, able to indicate the accumulative contact quantity index between the user and each member in a respective time period, such as all time up to the present time, the most recent week, the most recent month, and the most recent year, respectively.

In block S2, if the main directory M or one of the subdirectories M1-M3 is selected, the acquiring module 120 reads the communication records for each member from the storage system 11 according to the selection of the user, for obtaining the communication bulk and the communication count between the user and each member. For example, when the first subdirectory M1 is selected, the acquiring module 120 obtains information that the communication count between the user and one particular member in the most recent week is three times, and that the total communication bulk of the three telephone communications is eight minutes.

In block S3, the calculating module 130 calculates the accumulative contact quantity index for each member in the selected main directory M or subdirectory M1, M2 or M3 according to the communication bulk and the communication count. For example, the first weighting coefficient N of the communication count is preset to 0.9, and the second weighting coefficient P of the communication bulk is preset to 0.1. Thus in the above example, the accumulative contact quantity index is 3.5 (3*0.9+8*0.1).

In block S4, the ordering module 140 arranges the members of the selected main directory M or subdirectory M1, M2 or M3 of the address book 2 according to the accumulative contact quantity indexes of all the members. In the above example, when the first subdirectory M1 is selected, the member with a highest accumulative contact quantity index is arranged in a frontmost position of the first subdirectory M1, and the member with a lowest accumulative contact quantity index is arranged in a rearmost position of the first subdirectory M1.

When the accumulative contact quantity indexes of two members are the same, the two members can be shown in alphabetical order.

In summary, the address book management system 10 can obtain the communication bulk and the communication count between the user and each member via the acquiring module 120, and can calculate the accumulative contact quantity indexes via the calculating module 130. Then the ordering module 140 can arrange (list) the members of the address book 2 according to the calculated accumulative contact quantity indexes. The address book management system 10 directly shows, via the display screen 13, the members of the address book 2 in an ordered arrangement reflecting the values of their different accumulative contact quantity indexes. This is very convenient for the user to search and manage the members.

In other embodiments, the electronic device 1 can include more than one address book 2. For example, the electronic device 1 can include any two address books 2 selected from the group consisting of a telephone directory, a mailbox directory, and an instant chat directory; or the electronic device 1 can include all three address books of such group.

Although numerous characteristics and advantages of the exemplary embodiments have been set forth in the foregoing description, together with details of the structures and functions of the exemplary embodiments, the disclosure is illustrative only, and changes may be made in detail, especially in the matters of arrangement of parts within the principles of disclosure to the full extent indicated by the broad general meaning of the terms in which the appended claims are expressed.

What is claimed is:

1. An address book management method for an address book of an electronic device, the method comprising:
creating a directory of members of the address book;
obtaining a communication bulk and a communication count of each of the members listed in the address book, wherein the communication bulk for each member is a total quantity of electronic communication in a predetermined time period between a predetermined user of the electronic device and the member, the total quantity measured according to a predetermined criterion, and the communication count for each member is a total number of occasions of electronic communication between the user and the member in the predetermined time period;
calculating an accumulative contact quantity index for each member according to the calculated communication bulk and communication count of the member; and
ordering the members in the directory of the address book according to the calculated accumulative contact quantity indexes.

2. The address book management method of claim 1, further comprising displaying the ordered members in the directory of the address book.

3. The address book management method of claim 1, wherein calculating an accumulative contact quantity index for each member according to the calculated communication bulk and communication count of the member comprises predetermining a first weighting coefficient for the communication count and a second weighting coefficient for the communication bulk.

4. The address book management method of claim 3, wherein calculating an accumulative contact quantity index for each member according to the calculated communication bulk and communication count of the member further comprises obtaining the accumulative contact quantity index by adding an arithmetic product of the first weighting coefficient and the communication count to an arithmetic product of the second weighting coefficient and the communication bulk.

5. The address book management method of claim 1, wherein the directory is selected from the group consisting of a telephone directory, a mailbox directory and an instant chat directory.

6. The address book management method of claim 5, wherein the directory is a telephone directory, and the predetermined criterion for measuring the total quantity of electronic communication is a time period of each telephone communication.

7. The address book management method of claim 5, wherein the directory is a mailbox directory, and the predetermined criterion for measuring the total quantity of electronic communication is the electronic storage size of all the data of the text of each email communication.

8. The address book management method of claim 5, wherein the directory is an instant chat directory, and the predetermined criterion for measuring the total quantity of electronic communication is the electronic storage size of all the data of the text of each instant chat communication.

9. An electronic device, comprising:
a storage system;
at least one processor;
an address book; and
one or more programs stored in the storage system and executed by the at least one processor, the one or more programs comprising:
a creating module that creates a directory of members of the address book;
an acquiring module that reads a communication bulk and a communication count between a predetermined user of the electronic device and each of members listed in the address book from the storage system, wherein the communication bulk for each member is a total quantity of electronic communication in a predetermined time period between the user and the member, the total quantity measured according to a predetermined criterion, and the communication count for each member is a total number of occasions of electronic communication between the user and the member in the predetermined time period;
a calculating module that calculates an accumulative contact quantity index for each member according to the calculated communication bulk and communication count of the member; and
an ordering module that arranges the members of the address book for display according to the calculated accumulative contact quantity indexes.

10. The electronic device of claim 9, wherein the directory indicates the accumulative contact quantity index between the user and each member in the predetermined time period.

11. The electronic device of claim 10, wherein the time period is selected from the group consisting of all time up to the present time, the most recent week, the most recent month, and the most recent year.

12. The electronic device of claim 9, wherein the ordering module arranges the member with a highest accumulative contact quantity index in a frontmost position of the directory, and arranges the member with a lowest accumulative contact quantity index in a rearmost position of the directory.

13. The electronic device of claim 9, wherein the calculating module predetermines a first weighting coefficient for the communication count and a second weighting coefficient for the communication bulk according to an instruction of the user.

14. The electronic device of claim 13, wherein the calculating module obtains the accumulative contact quantity index by adding an arithmetic product of the first weighting coefficient and the communication count to an arithmetic product of the second weighting coefficient and the communication bulk.

15. A non-transitory storage medium having stored thereon instructions that, when executed by at least one processor of an electronic device, causes the electronic device to perform a method for managing an address book of the electronic device, the method comprising:
creating a directory of members of the address book;
obtaining a communication bulk and a communication count of each of the members listed in the address book, wherein the communication bulk for each member is a total quantity of electronic communication in a predetermined time period between a predetermined user of the electronic device and the member, the total quantity measured according to a predetermined criterion, and the communication count for each member is a total number of occasions of electronic communication between the user and the member in the predetermined time period;
calculating an accumulative contact quantity index for each member according to the calculated communication bulk and communication count of the member; and
ordering the members in the directory of the address book according to the calculated accumulative contact quantity indexes.

16. The storage medium of claim 15, wherein the directory indicates the accumulative contact quantity index between the user and each member in the time period.

17. The storage medium of claim 16, wherein the time period is selected from the group consisting of all time up to the present time, the most recent week, the most recent month, and the most recent year.

18. The storage medium of claim 15, wherein the member with a highest accumulative contact quantity index is arranged in a frontmost position of the directory, and the member with a lowest accumulative contact quantity index is arranged in a rearmost position of the directory.

19. The storage medium of claim 15, wherein a first weighting coefficient is predetermined for the communication count, and a second weighting coefficient is predetermined for communication bulk.

20. The storage medium of claim 19, wherein the accumulative contact quantity index is calculated by adding an arithmetic product of the first weighting coefficient and the communication count to an arithmetic product of the second weighting coefficient and the communication bulk.
